(19) United States
(12) Patent Application Publication
(10) Pub. No.: US 2016/0105828 A1
(43) Pub. Date: Apr. 14, 2016

(54) Communication Device of Handling Network-based Internet Protocol Flow Mobility

(71) Applicant: HTC Corporation, Taoyuan City (TW)

(72) Inventors: Hsien-Hao Lai, Taoyuan City (TW); Chih-Hsiang Wu, Taoyuan City (TW)

(21) Appl. No.: 14/882,442

(22) Filed: Oct. 13, 2015

Related U.S. Application Data
(60) Provisional application No. 62/063,895, filed on Oct. 14, 2014.

(51) Int. Cl. H04W 36/00; H04W 28/10

(52) U.S. Cl. CPC H04W 36/0077; H04W 28/10

(57) ABSTRACT

A communication device which communicates with a network apparatus via a packet data network (PDN) connection simultaneously relying on a first access and a second access is disclosed. The communication device comprises a storage unit for storing instructions of transmitting a first message indicating a status of the second access to the network apparatus; and receiving a second message transmitted by the network apparatus, wherein the second message includes configuration indicating transferring one or more Internet Protocol (IP) flows between the first access and the second access, wherein the first access is used to access a cellular network, and the second access is used to access a non-cellular network; and a processing means, coupled to the storage unit, configured to execute the instructions stored in the storage unit.

### CROSS REFERENCE TO RELATED APPLICATIONS

This application claims the benefit of U.S. Provisional Application No. 62/063,895 filed on Oct. 14, 2014 and entitled “UE measurement report for NBIFOM service”, the contents of which are incorporated herein by reference.

### BACKGROUND OF THE INVENTION

1. Field of the Invention

The present invention is related to a communication device used in a wireless communication system, and more particularly, to a communication device of handling network-based internet protocol flow mobility.

2. Description of the Prior Art

A long-term evolution (LTE) system supporting the 3rd Generation Partnership Project (3GPP) Rel-8 standard and/or the 3GPP Rel-9 standard are developed by the 3GPP as a successor of a universal mobile telecommunications system (UMTS), for further enhancing performance of the UMTS to satisfy increasing needs of users. The LTE system includes a new radio interface and a new radio network architecture that provides a high data rate, low latency, packet optimization, and improved system capacity and coverage. In the LTE system, a radio access network known as an evolved universal terrestrial radio access network (E-UTRAN) includes multiple evolved Node-Bs (eNBs) for communicating with multiple user equipments (UEs), and for communicating with a core network including a mobility management entity (MME), a serving gateway, etc., for Non-Access Stratum (NAS) control.

A LTE-advanced (LTE-A) system, as its name implies, is an evolution of the LTE system. The LTE-A system targets faster switching between power states, improves performance at the coverage edge of an eNB, and includes advanced techniques, such as carrier aggregation (CA), coordinated multipoint (CoMP) transmission/reception, uplink multiple-input multiple-output (UL-MIMO), etc. For a UE and an eNB to communicate with each other in the LTE-A system, the UE and the eNB must support standards developed for the LTE-A system, such as the 3GPP Rel-10 standard or later versions.

Network-based internet protocol flow mobility (NBIFOM) features that a packet data network (PDN) connection may rely on two access links to connect to a PDN gateway (PGW). That is, when a UE connects to a network via both a 3GPP access and a non-3GPP (such as WiFi) access, the UE can communicate using multiple accesses simultaneously for a PDN connection if the UE is authorized by all of the involved accesses for this PDN connection. A PDN connection consists of one or more IP (internet protocol) flows; IP flow mobility introduces the concept of treating IP flows individually within a PDN connection. IP packets of an IP flow are communicated on an EPS bearer via 3GPP access between the UE and network. In such a situation, the UE or network could move one or more IP flows between the available accesses based on characteristics of the IP flows and capabilities of the available accesses. However, the network does not know whether non-3GPP access of the UE is available or the UE supports NBIFOM. Therefore an IP flow transfer from the 3GPP to non-3GPP access may fail.

### SUMMARY OF THE INVENTION

It is therefore an objective of the present invention to provide communication devices and a network apparatus capable of optimizing 3GPP to non-3GPP accesses between the communication device and the network apparatus.

The present invention discloses a communication device, communicating with a network apparatus via a packet data network (PDN) connection simultaneously relying on a first access and a second access, the communication device comprising a storage unit for storing instructions of transmitting a first message indicating a status of the second access to the network apparatus; and receiving a second message transmitted by the network apparatus, wherein the second message includes configuration indicating transferring one or more Internet Protocol (IP) flows between the first access and the second access, wherein the first access is used to access a cellular network, and the second access is used to access a non-cellular network; and a processing means, coupled to the storage unit, configured to execute the instructions stored in the storage unit.

The present invention further discloses a communication device, communicating with a network apparatus via a packet data network (PDN) connection relying on first and second accesses, the communication device comprising a storage unit for storing instructions of transmitting a first message to the network apparatus, wherein the first message indicates the connected second access and configuration which includes one or more Internet Protocol (IP) flows for transferring between the first access and the second access, wherein the first access is used to access a cellular network, and the second access is used to access a non-cellular network; and a processing means, coupled to the storage unit, configured to execute the instructions stored in the storage unit.

The present invention further discloses a network apparatus, communicating with a communication device via a packet data network (PDN) connection simultaneously relying on a first access and a second access, the network apparatus comprising a storage unit for storing instructions of receiving a first message transmitted by the communication device indicating a status of the second access; and transmitting a second message to the communication device, wherein the second message comprises configuration indicating transferring one or more Internet Protocol (IP) flows between the first access and the second access, wherein the first access is used to access a cellular network, and the second access is used to access a non-cellular network; and a processing means, coupled to the storage unit, configured to execute the instructions stored in the storage unit.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a communication system according to an embodiment of the present invention.

FIG. 2 is a schematic diagram of a communication device of the communication system of FIG. 1.

FIGS. 3-5 are flowcharts of processes for the communication device of FIG. 2.

### DETAILED DESCRIPTION

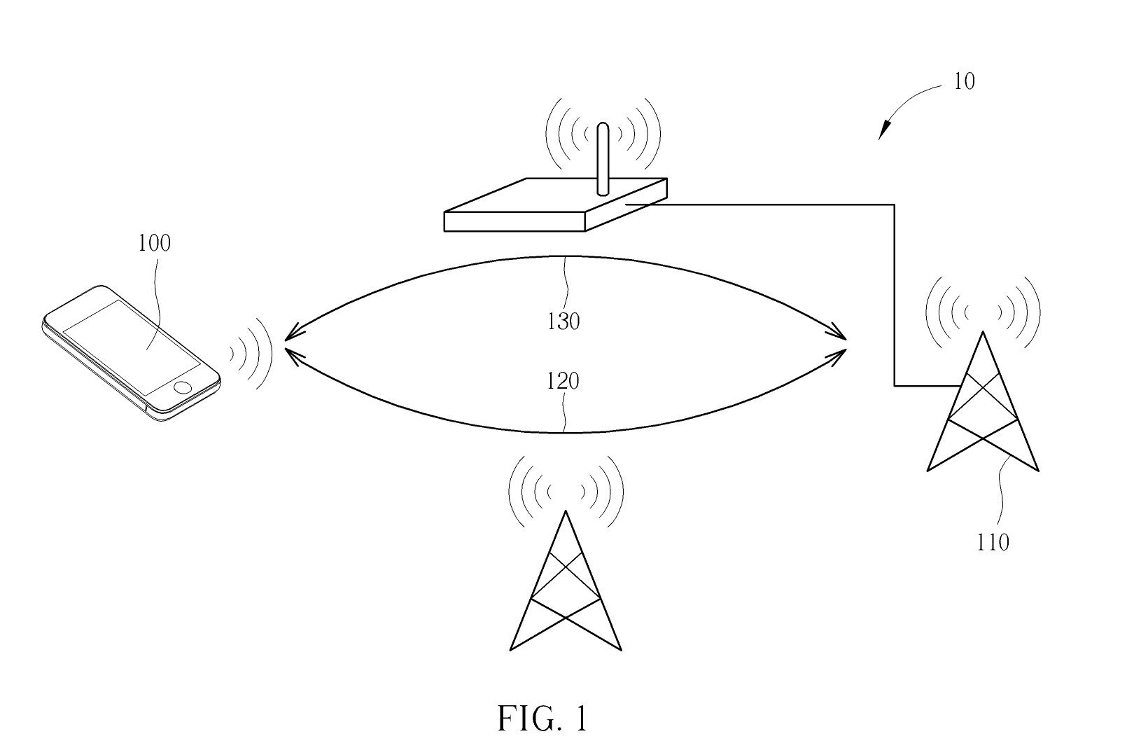

Please refer to FIG. 1, which is a schematic diagram of a communication system 10 according to an embodiment of the present invention. The communication system 10 includes a communication device 100 (e.g. a smartphone) and a network apparatus 110 (e.g. a gateway) support Network-based internet protocol flow mobility (NBIFOM). The communication device 100 and the network apparatus 110 may communicate with each other via a packet data network (PDN) connection simultaneously relying on a first access 120, a cellular network such as 3GPP network, and a second access 130, a non-cellular network such as Wi-Fi network.

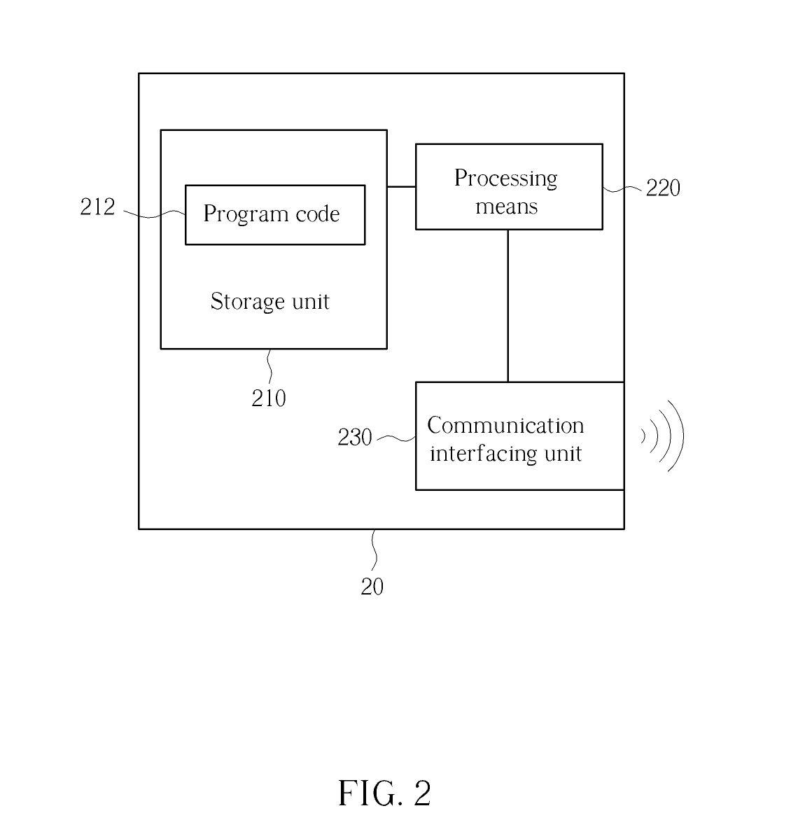

Please refer to FIG. 2, which is a schematic diagram of a communication device 20 according to an example of the present invention. The architecture of the communication device 20 may be employed in the communication device 100 or the network apparatus 110 shown in FIG. 1, but is not limited herein. The communication device 20 includes a storage unit 210, a processing means 220 such as a microprocessor or Application Specific Integrated Circuit (ASIC), and a communication interfacing unit 230. The storage unit 210 may be any data storage device that may store a program code 210, accessed and executed by the processing means 220. The processing means 220 is configured to execute the instructions stored in the storage unit 210. The communication interfacing unit 230 is preferably a transceiver and is used to transmit and receive signals (e.g., data, signals, messages and/or packets) according to processing results of the processing means 220.

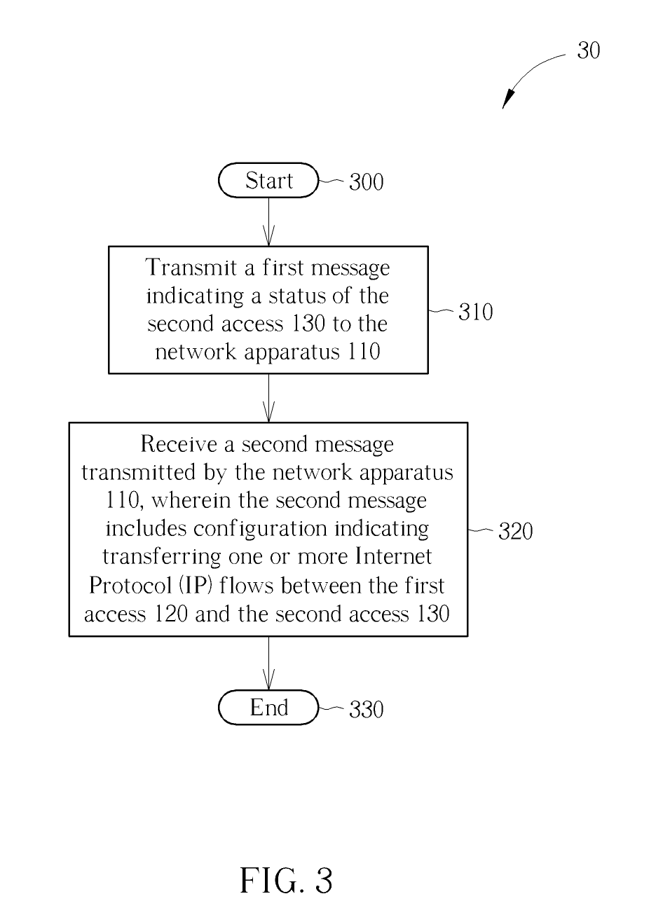

Please refer to FIG. 3, which is a flowchart of a process 30 according to an example of the present invention. The process 30 may be utilized in the communication device 100 of the communication system 10 shown in FIG. 1, for handling NBIFOM. The process 30 may be compiled into the program code 210 and includes the following steps:

Step 300: Start.

Step 310: Transmit a first message indicating a status of the second access 130 to the network apparatus 110.

Step 320: Receive a second message transmitted by the network apparatus 110, wherein the second message includes configuration indicating transferring one or more Internet Protocol (IP) flows between the first access 120 and the second access 130.

Step 330: End.

According to the process 30, the communication device 100 transmits the first message indicating the status of the second access 130 to the network apparatus 110, and receives the second message from the network apparatus 110, wherein the second message includes configuration indicating transferring one or more IP flows between the first access 120 and the second access 130. In other words, the communication device 100 reports the status of the second access 130 via the first message to the network, such that the network apparatus 110 can determine the configuration between the first and second accesses 120, 130 based on the first message. As a result, the failure of transferring the IP flows between the first and second accesses 120, 130 can be avoided.

Note that, the Step 310 may be performed under one or more conditions. In one example, the step 310 may be performed when the second access 130 is activated or connected. In one example, the step 310 may be performed when the second access is deactivated or the connection of the second access is lost. In one example, the step 310 may be performed when signal strength of the second access 130 is above or below a threshold. In another example, the step 310 may be performed when a new PDN connection is established on the second access 130.

For example, the communication device 100 is a smartphone, the first access 120 is used to access a cellular network (e.g. LTE or UTRAN) and the second access 130 is used to access a non-cellular (e.g. WLAN). The communication 100 has one or more IP flows over the 3GPP access. When the user of the communication device 100 comes home, the communication device 100 simultaneously connects to a 3GPP network (the network apparatus 110) via the 3GPP (first) and WiFi (second) accesses. The WiFi access is presumed to have better data rate than the 3GPP access at home so the communication device may want to transmit and/or receive IP packets of the one or more IP flows via the WiFi access. In such a situation, the communication device 100 may send a first message indicating the WiFi access is available, preferred or connected to the WLAN. The first message may indicate WiFi signal strength, to the network apparatus 110. The network apparatus 110 transmits a second message which includes configuration of one or more IP flows to be transferred from the 3GPP access to the WiFi access, to the communication device 100. The configuration may include at least one of source IP address, destination IP address, port number and an identity for identifying each of the one or more one IP flows. The communication device 100 may transfer the one or more IP flows identified by the configuration in the second message, from the 3GPP access to the WiFi access by communicating IP packets of the one or more IP flows via the WiFi access. Then the communication device 100 and network communicate IP packets of the one or more IP flows via the WiFi access. It is noted that the UE and network may communication some IP packets of an IP flow of the one or more IP flows via the 3GPP access if an EPS bearer for the IP flow is not released. Data rate are increased for the IP flow since both 3GPP access and WiFi access are utilized for the IP flow. In another example, according to characteristics of an IP flow of the one or more IP flows, the default setting of the communication device or user preference, the communication device 100 may determine not to transfer the IP flow of the one or more IP flows.

In one example, after receiving the second message from the network apparatus 110, the communication device 100 may request Bearer Resource Modification procedure to move the agreed IP flows from the 3GPP access to the WiFi access. In another example, the communication device 100 may not transmit any message to notifying the network about transferring and directly communicates IP packets of the one or more IP flows via the WiFi access.

If a decision of traffic steering is changed, the WiFi access is deactivated, the WiFi signal is poor or lost or the WiFi data rate is worse, the communication device 100 may transmit a first message indicating the WiFi access is unavailable or not preferred according to the process 30, such that the network apparatus 110 may transmit a second message which indicates transferring the one or more IP flows from the WiFi access to 3GPP access.

The communication device 100 receives RAN (radio access network) assistance parameter e.g. Thresh_{BeaconRSSIWLAN, Low} (the beacon RSSI threshold of Wireless Local Area Network, WLAN) from the 3GPP access node, the non-3GPP radio access node or the ANDSF server. The communication device 100 uses the RAN assistance parameter to decide whether to steer traffic between 3GPP access and WiFi access. In one example, the value of the beacon RSSI measured by the communication device is larger than the Thresh_{BeaconRSSIWLAN, Low} provided by the 3GPP access, the communication device 100 may transmit a first message to trigger the traffic steering from 3GPP access to WiFi access.

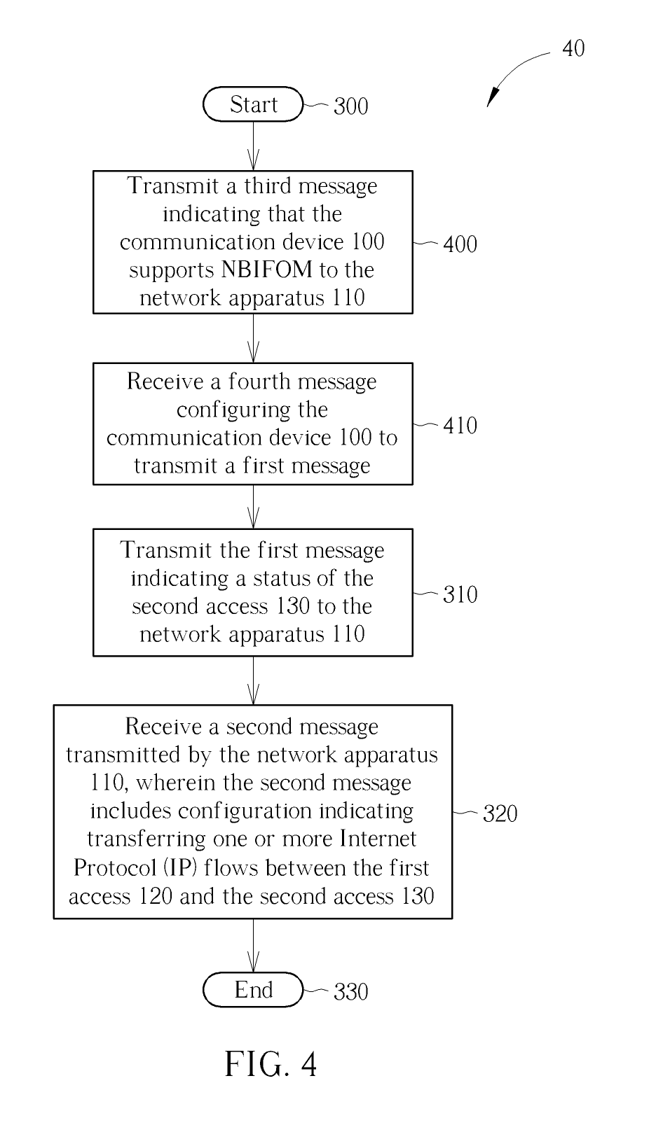

Prior to the Step 310, the communication device 100 may further transmit a third message indicating that the communication device 100 supports NBIFOM to the network apparatus 110. In response to the third message, the network apparatus 110 may transmit a fourth message to the communication device 100, so as to configure the communication device 100 to transmit the first message. As such, the process 30 is expanded to be a process 40 illustrated in FIG. 4. The process 40 includes new inserted Steps 400 and 410 compared to the process 30.

Step 400: Transmit a third message indicating that the communication device 100 supports NBIFOM to the network apparatus 110.

Step 410: Receive a fourth message configuring the communication device 100 to transmit the first message.

Specifically, the third message may be ATTACH REQUEST, ATTACH COMPLETE, TRACKING AREA UPDATE REQUEST, TRACKING AREA UPDATE COMPLETE, SERVICE REQUEST, PDN CONNECTIVITY REQUEST, BEARER RESOURCE ALLOCATION REQUEST, ACTIVATE DEFAULT EPS BEARER CONTEXT ACCEP, ACTIVATE DEDICATED EPS BEARER CONTEXT ACCEPT, or a new non-access stratum (NAS) message, which indicate the second access 130 connecting the communication device 100 and the network apparatus 110.

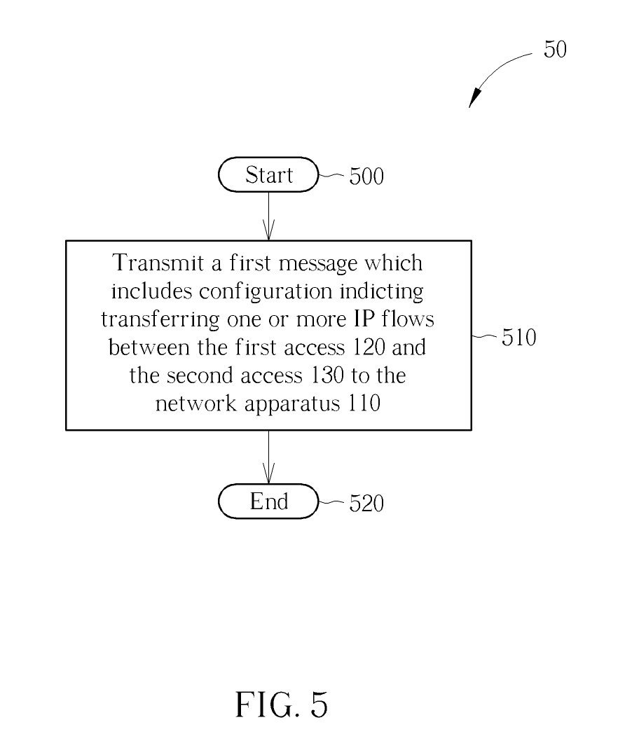

In the processes 30, 40, the configuration between the first and second accesses 120, 130 is determined by the network apparatus 110. Alternatively, the configuration may be determined by the communication device 100. In detail, please refer to FIG. 5, which is a flowchart of a process 50 according to an embodiment of the present invention. The process 50 can also be applied to the communication system 10, in which the communication device 100 communicates with the network apparatus 110 via the first access 120. The process 50 includes the following steps:

Step 500: Start.

Step 510: Transmit a first message which includes configuration indicting transferring one or more IP flows between the first access 120 and the second access 130 to the network apparatus 110.

Step 520: End.

According to the process 50, the communication device 100 transmits the first message including the configuration which includes configuration indicting transferring one or more IP flows between the first access 120 and the second access 130 to the network apparatus 110. In contrary to the process 30, the configuration is determined by the communication device 100 instead of the network apparatus 110. It is noted that the Step 510 may be performed when a RAN assistance parameter, e.g. Thresh_{BeaconRSSIWLAN, Low} is provided by the 3GPP access node, the non-3GPP radio access node or the ANDSF server, is changed, when the second access 130 is lost or connected to the non-3GPP radio access node, or when a new PDN connection is established.

For example, the communication device 100 is a smartphone, the first access 120 is a 3GPP access and the second access 130 is a WiFi access. The communication 100 has one or more IP flows over the 3GPP access. When the user of the communication device 100 comes home, the communication device 100 simultaneously connects to a 3GPP network (the network apparatus 110) via the 3GPP (first) and WiFi (second) accesses. The WiFi access is presumed to have better data rate than the 3GPP access at home so the communication device may want to transmit and/or receive IP packets of the one or more IP flows via the WiFi access. In such a situation, the communication device 100 may send a first message including configuration indicating transferring the one or more Internet Protocol (IP) flows to the WiFi access to the network apparatus 110. The first message may further indicate the WiFi access is available or preferred, or WiFi signal strength. According to characteristics of IP flows, the user's calling fee or the operator policy, the network apparatus 110 may send a second message which grants some or all of the one or more IP flows in the configuration in the first message to be transferred from the 3GPP access to the WiFi access.

In one example, after receiving the second message from the network apparatus 110, the communication device 100 may request Bearer Resource Modification procedure to move the agreed IP flows from the 3GPP access to the WiFi access. In another example, the communication device 100 may not transmit any message to notifying the network about transferring and directly communicates IP packets of the one or more IP flows via the WiFi access.

If a decision of traffic steering is changed, the WiFi signal is poor or lost or the WiFi data rate is worse, the communication device 100 may transmit a first message which includes configuration indicating transferring the one or more IP flows from the WiFi access to 3GPP access according to the process 50. The first message may or may not further indicate the WiFi access is unavailable or not preferred.

In one example, the value of the beacon RSSI measured by the communication device 100 is lower than the Thresh_{BeaconRSSIWLAN, Low} provided by the 3GPP access, the communication device 100 may transmit a first message to steer the traffic from WiFi access to 3GPP access.

Those skilled in the art should readily make combinations, modifications and/or alterations on the abovementioned description and examples. The abovementioned steps of the processes including suggested steps can be realized by means that could be a hardware, a firmware known as a combination of a hardware device and computer instructions and data that reside as read-only software on the hardware device, or an electronic system. Examples of hardware can include analog, digital and mixed circuits known as microcircuit, microchip, or silicon chip. Examples of the electronic system can include a system on chip (SOC), system in package (SiP), a computer on module (COM), and the communication device 100.

To sum up, in order to configure NBIFOM, the communication device reports the status of the non-mobile network to the network apparatus, or determines IP traffic steer for IP flows based on the status according to the embodiments of the present invention. As a result, the communication device and the network apparatus can use the status to optimize the transmission capability of the PDN connection.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A communication device, communicating with a network apparatus via
a packet data network (PDN) connection simultaneously relying on a first access and a second access, the communication device comprising:
a storage unit for storing instructions of:
transmitting a first message indicating a status of the second access to the network apparatus; and
receiving a second message transmitted by the network apparatus, wherein the second message includes configuration indicating transferring one or more Internet Protocol (IP) flows between the first access and the second access, wherein the first access is used to access a cellular network, and the second access is used to access a non-cellular network; and
a processing means, coupled to the storage unit, configured to execute the instructions stored in the storage unit.

2. The communication device of claim 1, wherein the instruction of transmitting the first message indicating the status of the second access is executed when a traffic steering decision is changed, when the second access is lost or connected to the non-cellular network or when a new PDN connection is established on the second access.

3. The communication device of claim 1, wherein the instructions further comprise:
transmitting a third message indicating the communication device supporting Network-based IP flow mobility (NBIFOM) to the network apparatus.

4. The communication device of claim 3, wherein the third message is a NAS message, such as ATTACH REQUEST, ATTACH COMPLETE, TRACKING AREA UPDATE REQUEST, TRACKING AREA UPDATE COMPLETE, SERVICE REQUEST, PDN CONNECTIVITY REQUEST, BEARER RESOURCE ALLOCATION REQUEST, ACTIVATE DEFAULT EPS BEARER CONTEXT ACCEP, ACTIVATE DEDICATED EPS BEARER CONTEXT ACCEPT, or a new NAS message, which indicates the second access connecting the communication device and the network apparatus.

5. The communication device of claim 1, wherein the instructions further comprise:
receiving a fourth message transmitted by the network apparatus, wherein the fourth message is utilized for configuring the communication device to transmit the first message.

6. The communication device of claim 1, wherein the instructions further comprise:
moving some or all of the one or more IP flows specified in the configuration in the second message.

7. A communication device, communicating with a network apparatus via a packet data network (PDN) connection relying on first and second accesses, the communication device comprising:
a storage unit for storing instructions of:
transmitting a first message to the network apparatus, wherein the first message indicates the connected second access and configuration which includes one or more Internet Protocol (IP) flows for transferring between the first access and the second access, wherein the first access is used to access a cellular network, and the second access is used to access a non-cellular network; and
a processing means, coupled to the storage unit, configured to execute the instructions stored in the storage unit.

8. The communication device of claim 7, wherein the instruction of transmitting the first message to the network apparatus is executed when an assistance radio access network (RAN) parameter is changed, when the second access is lost or connected to the non-cellular network, or when a new PDN connection is established.

9. The communication device of claim 7, wherein the instructions further comprise:
receiving a second message transmitted by the network apparatus, wherein the second message comprises a configuration which grants some or all of the one or more IP flows included in the configuration in the first message.

10. The communication device of claim 9, wherein the instructions further comprise:
moving the granted some or all of the one or more IP flows between the first access and the second access according to the configuration in the second message.

11. A network apparatus, communicating with a communication device via a packet data network (PDN) connection simultaneously relying on a first access and a second access, the network apparatus comprising:
a storage unit for storing instructions of:
receiving a first message transmitted by the communication device indicating a status of the second access; and
transmitting a second message to the communication device, wherein the second message comprises configuration indicating transferring one or more Internet Protocol (IP) flows between the first access and the second access, wherein the first access is used to access a cellular network, and the second access is used to access a non-cellular network; and
a processing means, coupled to the storage unit, configured to execute the instructions stored in the storage unit.

12. The network apparatus of claim 11, wherein the instruction of receiving a first message transmitted by the communication device indicating a status of the second access is executed when a traffic steering decision is changed, when the second access is lost or connected to the non-cellular network or when a new PDN connection is established on the second access.

13. The network apparatus of claim 11, wherein the instructions further comprise:
receiving a third message transmitted by the communication device indicating the communication device supporting Network-based IP flow mobility (NBIFOM) to the network apparatus.

14. The network apparatus of claim 13, wherein the third message is a NAS message, such as ATTACH REQUEST, ATTACH COMPLETE, TRACKING AREA UPDATE REQUEST, TRACKING AREA UPDATE COMPLETE, SERVICE REQUEST, PDN CONNECTIVITY REQUEST, BEARER RESOURCE ALLOCATION REQUEST, ACTIVATE DEFAULT EPS BEARER CONTEXT ACCEP, ACTIVATE DEDICATED EPS BEARER CONTEXT ACCEPT, or a new NAS message, which indicates the second access connecting the communication device and the network apparatus.

15. The network apparatus of claim 11, wherein the instructions further comprise:
transmitting a fourth message, wherein the fourth message is utilized for configuring the communication device to transmit the first message.
